(19) United States
(12) Patent Application Publication
(10) Pub. No.: US 2003/0043241 A1
(43) Pub. Date: Mar. 6, 2003

(54) Ink absorbent, ink tank, ink jet cartridge, method for manufacturing ink absorbent, and method for manufacturing ink tank

(76) Inventors: Shozo Hattori, Tokyo (JP); Hajime Yamamoto, Yokohama-shi (JP); Eiichiro Shimizu, Yokohama-shi (JP); Jun Hinami, Yokohama-shi (JP); Kenta Udagawa, Kawasaki-shi (JP); Shuzo Iwanaga, Kawasaki-shi (JP)

Correspondence Address: FITZPATRICK CELLA HARPER & SCINTO, 30 ROCKEFELLER PLAZA, NEW YORK, NY, 10112, US

(21) Appl. No.: 09/543,331

(22) Filed: Apr. 5, 2000

(30) Foreign Application Priority Data
Apr. 5, 1999 (JP) 11-097854
Apr. 6, 1999 (JP) 11-098997

(51) Int. Cl. B41J 2/175

(52) U.S. Cl. 347/86

(57) ABSTRACT

An ink absorbent is contained in the housing of an ink tank for storing ink in the interior thereof, which is provided with a supply port for leading out ink to the outside, and an atmospheric communication port to be communicated with the air outside, and the ink absorbent is formed by fiber material having the surface formed at least by thermoforming. For this ink absorbent, the face which faces the supply port on the inner face of the ink tank is a cut face. With the structure thus arranged, the ink absorbent is prepared to provide cut faces to make the fiber absorbent softer than the thermoformed surface. Then, with the deformability and resiliency of the ink absorbent itself thus obtained, the close contactness with the inner walls of the ink tank is enhanced to prevent not only the ink shortage and ink leakage due to the air pass, but also, prevent the ink absorbent from being deviated when installed.

### BACKGROUND OF THE INVENTION

1. Field of the Invention

The present invention relates to an ink absorbent used for retaining ink to be supplied to an ink jet recording head that records by discharging ink, an ink tank formed by use of such ink absorbent, and an ink jet cartridge formed integrally with such ink tank and an ink jet recording head. The invention also relates to a method for manufacturing such ink absorbent, and a method for manufacturing such ink tank.

2. Related Background Art

With the ink supply to an ink jet recording head in view, it has conventionally been practiced in general that a structure is arranged in an ink tank to adjust pressure on ink retained in the ink tank for the execution of ink jet recording, such as, an ink tank structured in a mode whereby to mount it on a carriage together with an ink jet recording head, for example. Here, the pressure of the kind is termed negative pressure, because the pressure is made negative to the atmospheric pressure in the discharge port unit.

As an example of the structure to generate negative pressure in an ink tank, there is the one in which an ink absorbent is arranged inside the ink tank, and that the capillary force of this absorbent is utilized for generating the negative pressure.

In case where an ink absorbent of the kind is installed in an ink tank, the ink absorbent is usually compressed for installation several times the installation space in the ink tank. In this case, before the ink absorbent is installed in the ink tank, the size of the ink absorbent is determined so that the product of the compression ratio and the amount of holes against the installation space in the ink tank should be within a specific range (in order to form a specific condition of the negative pressure). Then, the ink absorbent formed in sheet or block is cut into smaller ones of a specific size and shape without compression, respectively. Then, each of the ink adsorbents thus cut is compressed to be slightly smaller than the installation space of the absorbent in the ink tank and inserted into it.

In this manner, the cut faces of the ink absorbent cut from the sheet or block absorbent without compression are made substantially flat.

However, the flat face thus formed by cutting is no longer flat as it has been cut when the absorbent is compressed to be inserted into the ink tank. The flat face is locally subjected to such a condition as if compressed unevenly. Then, in some cases, each of the cut faces is made irregular when compressed.

If the cut face thus compressed becomes irregular, there is a possibility that an unfavorable event takes place unexpectedly, such as, in some cases, gaps are created between the faces of the ink absorbent which has been inserted under compression, and the inner wall face of the ink tank.

In this case, it is conceivable that an ink pool is made in each gap, and ink in it may remain unused when recording is performed by use of such ink tank. Also, the ink flow is blocked by the ink pool to make the supply condition of ink inferior, hence inviting the degradation of print quality due to defective ink discharges in some cases.

Also, if the air, which is taken in from the atmospheric communication port provided for the ink tank or from the discharge ports of the printing head, should reside in the gaps, bubbles are mixed in ink which has been supplied to the printing head along the ink discharges, and may lead to the degradation of recording quality in some cases. Particularly, for an apparatus having the mode in which the ink tank unit and the printing head are formed integrally, and printing is performed by the scanning reciprocation of such integrated member, bubbles may easily mixed more in ink due to the scanning reciprocation that may cause the ink tank unit to vibrate.

Further, on the assumption that the vibration should exert influence, the deterioration of the ink absorbent occurs as the time elapses in the vicinity of the ink induction unit if a member is present in the ink induction unit of an ink jet head, which abuts against the ink absorbent. Then, there is a fear that a gap is formed in such portion. Conceivably, the unfavorable influence becomes more conspicuous by the air that stays in each gap. In the worst case, the atmospheric communication port provided for the ink tank is allowed to be communicated with the gaps in the vicinity of the ink induction unit. If a communication of the kind should occur, not only it becomes impossible to carry out the discharge operation as anticipated, but also, ink may leak from the ink discharge ports arranged for the ink supply paths, and stains the interior of the apparatus.

With these facts in view, the properties required for an ink absorbent are such that it can supply ink to an ink jet recording head sufficiently, while ink retained in the ink absorbent is not allowed to leak outside the ink tank unexpectedly, and at the same time, the amount of ink that should remain unused is as small as possible. In order for an ink absorbent to acquire such properties, a method for manufacturing an ink absorbent itself or the physical property of an ink absorbent should be controlled as one of effective means. In this respect, the inventors hereof have found that the shape of the cut faces of an ink absorbent used for an ink tank and an ink jet cartridge exert a great influence on the function of such control means.

On the other hand, there are some cases where all the cut faces of a smaller ink absorbent block which is cut from a larger sheet or block absorbent are not necessarily the faces that are formed by cutting. In other words, the surface layer of a larger sheet or block absorbent may remain intact as it is manufactured when cut into each of smaller blocks depending on a method for manufacturing smaller blocks.

The surface layer of a sheet or block absorbent is in a condition different from the inner condition of the absorbent due to thermoforming. As a result, when an absorbent is installed in an ink tank, a slight difference may take place as to the supply performance of ink depending on whether the cut face is placed toward the supply port portion or the surface layer is placed toward it. Even in a case where such difference is so slight as not to affect a usual recording noticeably, it is found that there is a definite difference in the supply performance of ink in the ink tank which may require such capabilities as to deal with a higher speed recording.

Now, a foaming member, like a urethane sponge, which is usable as one example of those members capable of generating negative pressure in an ink tank, has each of foaming cells in a state where each of them is separated by the presence of film when produced. Then, the film removal process is needed in order to use it as an ink absorbent. Also, there is a fear that elution is made due to the chemical stability of the foaming member itself or the like depending on the kind of ink to be used. This makes it necessary in some cases that the kind of ink is limited for use in some cases.

In order to solve the problems described above, it has been practiced in recent years to adopt an ink absorbent formed by fiber material. Particularly, the ink absorbent, which is made by the fiber material whose surface is thermoformed, is preferably adoptable for use of an ink tank having more complicated configuration with a process whereby to form the outer faces of such absorbent equal to or corresponding to the inner shape of the housing of the ink tank.

Nevertheless, if an ink absorbent of the fiber material whose surface is thermoformed is used, there still occurs a great difference in the conditions of the surface layer and cut faces as described earlier. Thus, it is found preferable from the viewpoint of the ink supply performance that each of the cut faces is conditioned to be adoptable as the plane that faces the ink supply port, in particular.

Also, if an ink absorbent of the fiber material whose surface is thermoformed is used, there are some cases where the contact condition becomes unfavorable between the inner wall on the ink tank side and the thermoformed surface of the ink absorbent which becomes the surface layer. Then, the air layer may be created inevitably on the interface between the inner wall on the ink tank side and the surface layer of such ink absorbent. In a state of the kind, the atmospheric communication port and ink flow paths are allowed to be communicated through the inner wall faces of the ink tank, hence inviting the defective ink supply inevitably.

Also, if a head and a tank are in the detachable mode, the supply tube on the head side is allowed to abut upon the surface layer of an absorbent. However, there may be a fear that an abutting state of the kind is not good enough to secure the airtightness as anticipated, thus degrading the performance of ink supply due to such condition of the connection as having an insecure airtightness eventually.

### SUMMARY OF THE INVENTION

With a view to solving the problems discussed above, the present invention is designed. It is an object of the invention to provide an ink absorbent that satisfies an excellent performance of ink supply by attaining the stable installation of the ink absorbent in an ink tank; an ink tank that uses such ink absorbent; an ink jet cartridge formed integrally with such ink tank and an ink jet head; and a method for manufacturing an ink absorbent, as well as a method for manufacturing an ink tank.

It is another object of the invention to provide an ink tank having an excellent performance of ink supply, as well as the enhanced performance of attaching and detaching of the ink tank to and from a head by improving the side face characteristics of an ink absorbent that faces the ink supply port; an ink jet cartridge formed integrally with such ink tank and an ink jet head; and a method for manufacturing an ink absorbent as well as a method for manufacturing an ink tank.

In order to achieve the aforesaid objects, the ink absorbent of the present invention is formed by fiber material and a face thereof is structured by a cut face.

Also, the ink absorbent is contained in the housing of an ink tank for storing ink in the interior thereof, which is provided with a supply port for leading out ink to the outside, and an atmospheric communication port to be communicated with the air outside, and the ink absorbent is formed by fiber material having the surface formed at least by thermoforming. For this ink absorbent, the face which faces the supply port on the inner face of the ink tank is a cut face.

It is preferable to form the face of the ink absorbent which abuts upon a rib on the inner face of the ink tank with the non-cut thermoformed face of the ink absorbent, and also, to form the face of the ink absorbent which faces the atmospheric communication port of the ink tank is the non-cut thermoformed face thereof.

Also, the ink absorbent of the present invention, which is contained in the housing of an ink tank for storing ink in the interior thereof and provided with a supply port for leading out ink to the outside, as well as an atmospheric communication port to be communicated with the air outside, is formed by fiber material having the surface formed at least by thermoforming. For this ink absorbent, the face which faces the plane having the largest area on the inner face of the ink tank is the cut face thereof.

The ink tank that contains this ink absorbent comprises a negative pressure generating member installation chamber; a liquid storage chamber communicated with the negative pressure generating member installation chamber through communication passage to store ink to be supplied to the negative pressure generating member installation chamber which is substantially closed with the exception of the communication portion; and a partition wall member having the communication passage, which partitions the negative pressure generating member installation chamber and the liquid storage chamber.

In this case, it is preferable to form the face of the ink absorbent that faces the partition wall member is the cut face thereof.

Also, the ink absorbent of the present invention, which is contained in the housing of an ink tank for storing ink in the interior thereof provided with a supply port for leading out ink to the outside, and an atmospheric communication port to be communicated with the air outside, is formed by fiber material having the surface formed at least by thermoforming. For this ink absorbent, the two faces which are opposite to each other are the cut faces.

Here, it is preferable to make the cut faces are parallel in the fiber direction.

In order to achieve the object of the present invention discussed above, an ink tank is also provided, which is capable of containing each of the various kinds of ink adsorbents referred to in the preceding paragraphs.

Also, the ink absorbent of the present invention is compressed and inserted into the interior of an ink tank housing for installation to retain ink. This ink absorbent is cut into the inner shape of the ink tank housing under the same condition of compression as at the time of insertion thereof into the ink tank. In this case, it is preferable to make the degree of compression at the time of cutting lower than that of the compressed state after the insertion into the ink tank. Further, to this ink absorbent, the one which is formed by foaming material, fiber material, or formed by laminating two or more fiber blocks is applicable.

Also, the ink tank of the present invention is provided with an ink absorbent capable of retaining ink, and a housing having said ink absorbent installed therein and an atmospheric communication port.

Also, the ink jet cartridge of the present invention comprises an ink tank provided with an ink absorbent capable of retaining ink, and a housing having the ink absorbent installed therein. For this ink tank, the ink absorbent is cut into the inner shape of the ink tank housing under the same compressed state as at the time of insertion into the ink tank. The ink jet cartridge is also provided with a printing head for discharging ink supplied from the ink tank.

Also, the method of the present invention for manufacturing an ink absorbent, which is compressed and inserted into an ink tank housing to be able to retain ink, comprises the step of making the ink absorbent to be in the same compressed state as at the time of insertion into the ink tank; and the step of cutting the ink absorbent into the inner shape of the ink tank housing.

Also, the method of the present invention for manufacturing an ink absorbent, which is compressed and inserted into an ink tank housing to be able to retain ink, comprises the steps of making the ink absorbent to be in the same compressed state as at the time of insertion into the ink tank; cutting the ink absorbent into the inner shape of the ink tank housing; and inserting the ink absorbent into the ink tank housing under compression.

In accordance with the present invention, the ink absorbent is prepared to provide cut faces to make the fiber absorbent softer than the thermoformed surface. Then, with the deformability and resiliency of the ink absorbent itself thus obtained, it becomes possible to enhance the close contactness with the inner walls of the ink tank, and prevent not only the ink shortage and ink leakage due to the air pass, but also, prevent the ink absorbent from being deviated when installed. Also, it becomes possible for the ink absorbent to secure the abutting condition appropriately with an ink jet recording head when it is used for the ink tank which is attachable to and detachable from the ink jet recording head.

Also, with the ink absorbent which is cut into the inner shape of an ink tank housing under the same compressed state as at the time of insertion to the ink tank, the ink absorbent is not allowed to create wrinkles when installed in the ink tank housing. Then, the ink absorbent is made to follow the shape of the inner shape of the ink tank. As a result, there is no possibility that any unexpected gaps are created between the faces of the ink absorbent thus inserted and the inner wall faces of the ink tank, hence making it possible to prevent the print quality from being degraded due to the remainders of ink in the ink pools and the unfavorable performance of ink supply. Also, it is possible to prevent the occurrence of an event that the atmospheric communication port provided for an ink tank is communicated with the unexpected gaps that may be created in the vicinity of the ink lead-out portion of an ink jet recording head. Thus, the discharge operation is not disabled due to such occurrence of unexpected communication between them.

### BRIEF DESCRIPTION OF THE DRAWINGS

FIGS. 1A and 1B are exploded perspective views which schematically illustrate an ink jet cartridge having the ink tank provided therefor in accordance with one embodiment of the present invention.

FIGS. 2A, 2B and 2C are views which schematically illustrate a method for manufacturing an ink absorbent in accordance with the present invention.

FIG. 3 is an exploded perspective view which shows another embodiment in accordance with the present invention.

FIGS. 4A and 4B are views which schematically illustrate the state of an ink absorbent when it is cut.

### DETAILED DESCRIPTION OF THE PREFERRED EMBODIMENTS

Hereinafter, with reference to the accompanying drawings, the embodiment will be described in accordance with the present invention.

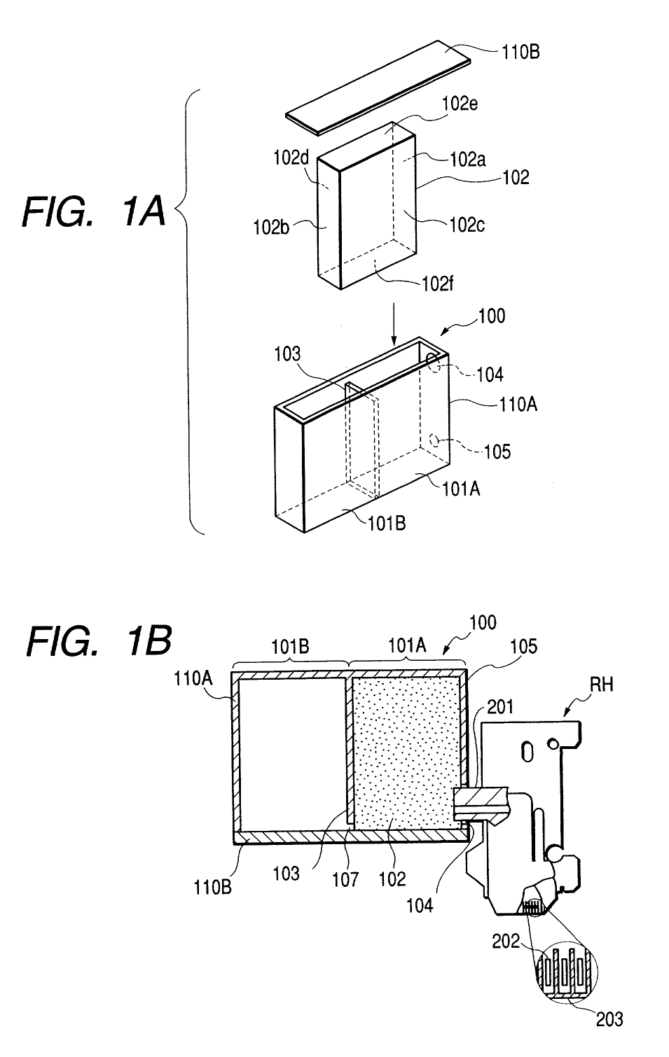

FIGS. 1A and 1B are exploded perspective views which schematically illustrate an ink cartridge having an ink tank provided therefor in accordance with an embodiment in accordance with the present invention. FIG. 1A is a schematic view which shows the ink cartridge. FIG. 1B shows the state where an ink jet head is installed on the ink tank.

In FIGS. 1A and 1B, by use of a partition wall 103, the ink tank 100 is provided with an ink absorbent installation chamber 101A where an absorbent is installed to generate negative pressure in the space in the container formed by housing 110A and the lower cover 110B with the exception of the communication path 107, and an ink storage chamber 101B. The ink tank is arranged to be separable from an ink jet head RH. The ink jet head RH discharges ink from the discharge ports 203 by the application of thermal energy generated by electrothermal converting elements 202. Ink is supplied to the liquid flow paths having electrothermal converting elements 202 arranged therefor through the supply tube 201 connected with the ink supply port 104 of the ink absorbent installation chamber.

The ink absorbent installation chamber 101A comprises the ink supply port 104 through which ink (including the processing liquid or the like that enhances the fixation of the recording liquid) is supplied to the outside, such as to the ink jet head RH; and the ink absorbent 102 formed by urethane foam, fiber material, or the like (the ink absorbent 102 shown in FIG. 1A is in a state of being compressed).

Further, the ink absorbent installation chamber 101A is provided with the atmospheric communication port 105 which enables the ink absorbent 102 installed in it to be communicated with the air outside. On the other hand, the ink storage chamber 101B is arranged to contain ink directly.

The ink absorbent 102 installed in the ink tank 100 has the outer face equal to or corresponding to the inner configuration of the ink absorbent installation chamber 101A. Fiber blocks are stacked and compressed to form the absorbent with the thermoformed surface. Further, the side face of the absorbent is cut to abut against the inner wall face of the ink absorbent installation chamber 101A.

Particularly, in accordance with the present embodiment, the ink absorbent 102 is formed in a block whose size is larger than that of the ink absorbent installation chamber 101A, and the position 102a and face 102b of the ink absorbent 102 which faces the ink supply port 104 of the ink tank 100 are formed by cut faces. Then, the hardness of the absorbent at these cut faces is made softer than that of the thermoformed surface.

Therefore, it becomes possible to secure the abutting condition between the ink supply tube 201 of the ink jet head RH and the ink absorbent 102 when the ink jet head is mounted. Also, the stress with which the ink supply tube 201 presses the surface of the ink absorbent is made easier at the position 102a. In addition, any unexpected air pass (ink shortage due to bubble) is prevented by the enhanced contactness between the ink supply plane of the ink absorbent installation chamber 101A and the corresponding side faces of the ink absorbent 102.

With the structure thus adopted, it becomes possible to suppress the mixture of bubbles in the ink supply tube 201, thus providing the structure capable of executing the performance of ink supply reliably.

In this respect, the locations where the cut faces are formed for an ink absorbent are not necessarily limited to the plane where the ink supply port is provided as described above. It may be possible to make each of the side faces a cut face, respectively, as given below.

For example, if the side face 102b that faces the partition wall 103 of the ink absorbent 102 and the side face 102e that becomes the contact face with the lower cover 110B are formed by the cut planes, it becomes possible to secure the close contactness with the partition wall 103 and the lower cover 110B. As a result, the air is prevented from flowing unexpectedly from the communication portion to the ink storage chamber 101B. The gas-liquid exchange can hardly occur unexpectedly so as to prevent the unwanted ink supply from the ink storage chamber 101B.

Further, if the side faces 102c and 102d of the ink absorbent 102 that face the maximum area of the ink absorbent installation chamber 101A, respectively, are formed by the cut planes, deformation and resiliency are provided for the ink absorbent 102 to make it possible to enhance the close contactness with the inner faces of the ink absorbent installation chamber 101A.

In this respect, it is more preferable to make the cut planes described above parallel to the fiber direction, because the planes thus arranged present a higher resiliency.

Now, the description has been made of the case where fiber is used for the ink absorbent for the formation thereof. However, it may be possible to equally adopt a porous member, such as a urethane sponge.

Further, for the structure of the present embodiment, it is more preferable to cut the ink absorbent 102 in a state where the ink absorbent is equally compressed to the one to be inserted into the ink absorbent installation chamber 101A so that the ink absorbent is in agreement with the inner configuration of the chamber 101A.

With the cutting in this manner, the cut planes are arranged to be in the same condition as being placed to match with the inner faces of the ink tank. As a result, it becomes possible to suppress the irregular surface condition that may be created as the local unevenness of compression which is made after having been cut without compression. Then, the cut planes are formed as the flat faces in the compressed condition to make it possible to secure the close contactness with the inner faces of the ink tank when the ink absorbent is installed in the ink tank.

Therefore, the ink tank 100 performs the ink supply smoothly without formation of any localized lines or unwanted spaces for the ink absorbent 102 in the installation chamber 101A, hence making it possible to perform printing in good condition.

Furthermore, since the ink is supplied from the ink storage chamber 101B to the ink absorbent installation chamber 101A by the operation of the gas-liquid exchange where the air flows into the ink storage chamber 101B along with the ink outlet from the ink storage chamber 101B, there is an advantage that ink is supplied substantially under a constant negative pressure during the operation of the gas-liquid exchange.

Moreover, since the cut planes are arranged to face the ink supply port, it becomes possible to provide the condition in which ink flows in good condition.

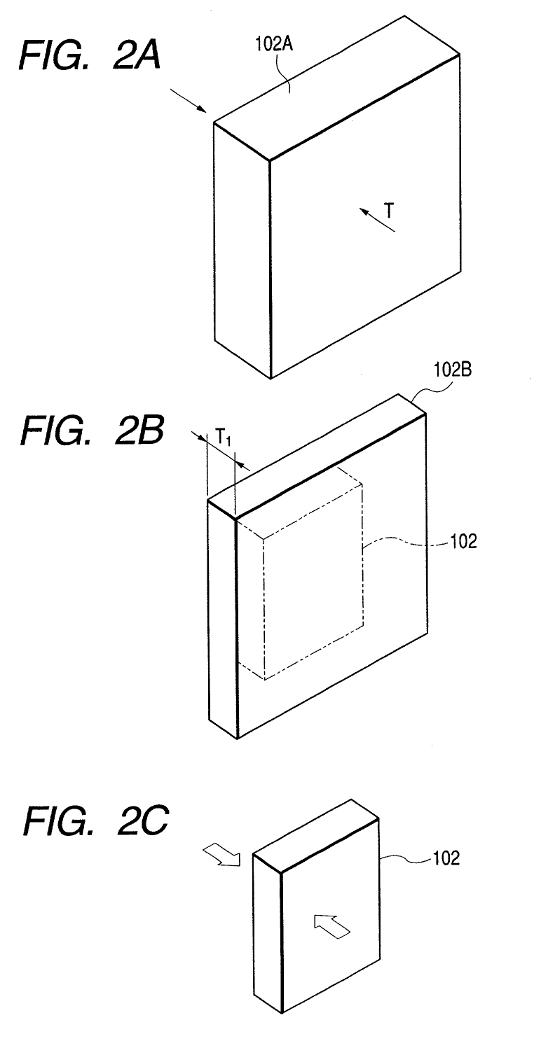

Now, in conjunction with FIGS. 2A to 2C, the description will be made of a method for manufacturing an ink absorbent in accordance with the present invention.

FIGS. 2A to 2C are views which schematically illustrate a method for manufacturing an ink absorbent. The ink absorbent 102A which is prepared in advance is in a block whose size is larger than the shape of a tank. The absorbent is formed by a fiber material produced by laminating two or more fiber blocks or by a foaming member, such as a urethane sponge.

The ink absorbent 102A thus prepared is compressed by use of a jig (not shown) in the same compressing direction T as at the time of being inserted into an ink tank (FIG. 2A). Then, the ink absorbent is compressed to match with the width T1 (see FIG. 1) of the ink absorbent installation chamber of the ink tank 100 housing. The jig which is not shown is provided with a slit along the shape of the ink absorbent installation chamber. The ink absorbent 102B is cut to follow the shape of the ink absorbent installation chamber of the ink tank 100 when it is cut along the slit provided for the jig, while kept in the state of being compressed by use of the jig (FIG. 2B). Here, the method for cutting an absorbent under compression is not necessarily limited the one described above. It may be possible to adopt any cutting method which is generally practiced.

Then, the ink absorbent 102 thus cut is compressed in the same compressing direction T as at the time of cutting (FIG. 2C), and inserted into the ink tank 100. Here, at least one or more of the cut faces of the ink absorbent 102 thus inserted are provided with the outer faces equal to or corresponding to the shape of the inner faces of the ink tank 100 housing. The ink absorbent 102, which is compressed and inserted into the ink tank 100 as described above, makes it possible to effectuate the ink supply smoothly without forming any local wrinkles or unwanted spaces, thus attaining the performance of printing in good condition.

For the above description, an example is made to cite a mode of an ink tank in which the ink absorbent is installed in the housing thereof. However, in order to enhance the ink storage efficiency per unit volume, it may be possible to apply the present invention to an ink tank which is provided with a space for storing an ink absorbent and a space for storing ink directly.

In accordance with the present invention described above, there is provided an ink absorbent which is cut into the inner shape of the ink tank housing in a state of being compressing as at the time of insertion. As a result, no space is created unexpectedly between the faces of the ink absorbent thus compressed and inserted, and those of the inner wall of the ink tank, hence making it possible to suppress the degradation of the print quality due to the ink remainders in the ink pools and the degraded performance of ink supply. Also, it becomes possible to prevent the atmospheric communication port provided for the ink tank and the unexpected gaps that may be created in the vicinity of the ink inducing section from being communicated atmospherically. Thus, there is no possibility that the discharge operation is disabled.

Also, in accordance with the present invention, the ink absorbent is cut in a state of being compressed. For the ink tank and the ink jet cartridge of the present invention, therefore, the ink absorbent can be cut to match with the complicated inner shape of an ink tank accordingly. As a result, variously structured ink tanks can also be manufactured to allow the designing of an ink jet recording apparatus more freely.

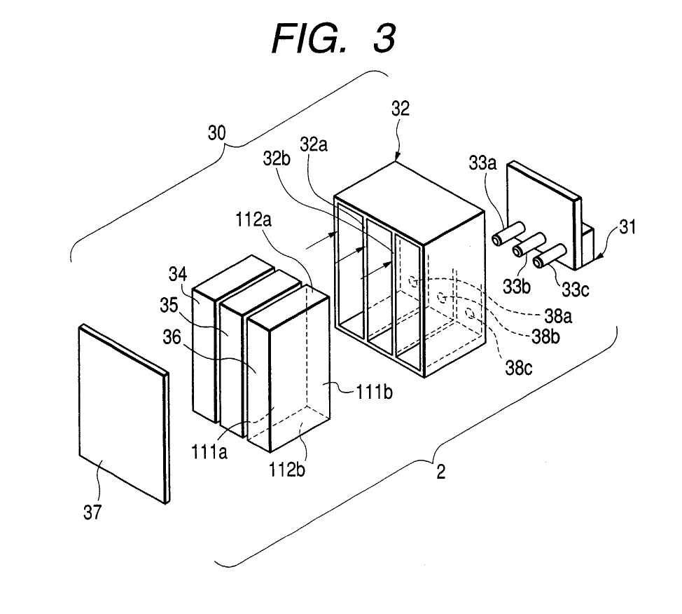

Now, with reference to FIG. 3, the description will be made of another embodiment in accordance with the present invention.

An ink cartridge 2 comprises an ink jet head 31 capable of discharging yellow (Y), magenta (M), cyan (C) ink, respectively, and an ink tank 30 detachably mountable on the ink jet head 31. The ink jet head 31 is connected with the ink tank 30 through ink supply tubes 33a, 33b, and 33c, and each color ink is supplied to the ink jet head 31 through corresponding ink supply tubes, respectively. The ink tank 30 is partitioned by two partitioning members 32a and 32b to separate the interior of the concave container 32, which forms a housing together with a covering member 37, into three chambers. In each of these chambers, ink adsorbents 34, 35, and 36 are installed to retain ink of Y, M, and C, respectively. In each of the chambers, an atmospheric communication port which is not shown is arranged so as to enable the interior of the housing to communicated with the air outside. Also, from the viewpoint of leakage prevention, a rib which is not shown is provided for a part of the inner configuration of each chamber.

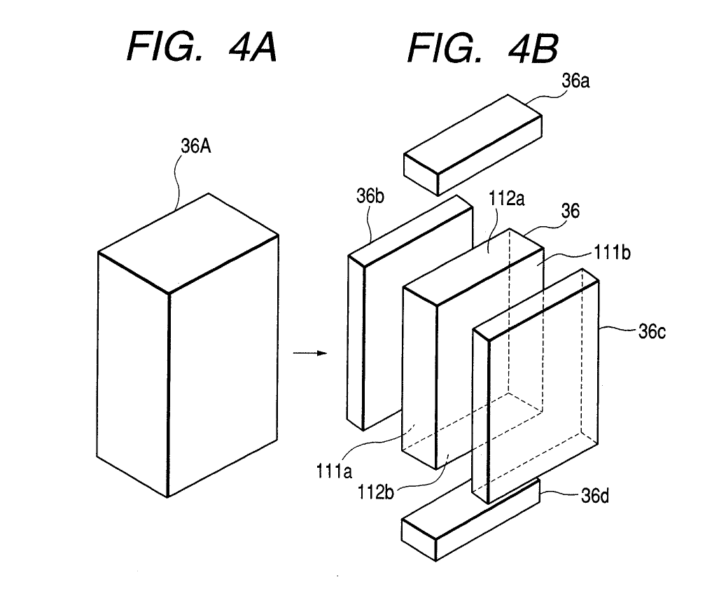

Each of ink adsorbents 34, 35, and 36, which is installed in the area (hereinafter referred to as an ink absorbent installation chamber or as a negative pressure generating member installation chamber), which is surrounded by the housing and separation wall members of the ink tank 30, retains ink, respectively. Each of the ink adsorbents 34, 35, and 36 has the outer faces equal to or corresponding to the inner face configuration of the negative pressure generating member installation chamber as in the embodiment previously described. Fiber blocks are laminated and compressed, and the surface thereof is thermoformed. Then, the structure is arranged so that it is cut as shown in FIGS. 4A and 4B at each position where it abuts against the inner wall face of the negative pressure generating member installation chamber when each of them is installed.

In the positions 111a, 111b, and 112a and 112b, which are orthogonal to the formation surfaces of the ink supply ports 38a, 38b, and 38c of the ink tank 30, the block ink absorbent 36A whose size is larger than that of the negative generating member installation chamber and whose surface is thermoformed is cut by means of the absorbent cutting method known generally, and then, the cut edges 36a, 36b, 36c, and 36d of the ink absorbent are removed to form the cut faces is formed eat at 111a, 111b, and 112a and 112b as described above. In this manner, the deformability and resiliency are provided for the ink adsorbents 34, 35, and 36, respectively. Thus, the abutting force, which may be exerted when the ink supply tubes 33a, 33b, and 33c of the ink jet head 31 abut upon each of the ink adsorbents 34, 35, and 36, respectively, is made easier to make it possible to reduce the force that may be exerted by the head 31 when it is installed.

Also, it is made easier to prevent each of the inner face ribs from being buried if the thermoformed surface (yet to be cut) is used as the surface that may abut against each of the inner ribs of the negative pressure generating member installation chamber.

Further, with the thermoformed surface (yet to be cut) which is placed in a position corresponding to the side face of the ink absorbent where the atmospheric communication port is provided, it becomes easier to retain ink, because the capillary force of such surface is higher than that of the cut surface, hence preventing ink from leaking more reliably.

For the present embodiment, too, it is preferable to cut each of the ink adsorbents to match with the inner configuration of the installation chamber under the same compressed state as at the time of being inserted into the negative pressure generating member installation chamber.

Also, it is possible to make the connecting condition better for each absorbent when it is connected with each of the ink supply tubes if the cut face is used for each side face of the ink absorbent that faces the ink supply port, respectively. It is preferable that with such arrangement, the ink flow is made in good condition as in the previous embodiment. In this respect, however, it may be possible to form a structure whereby to secure the performance of ink supply with the capillary force which is made higher than that of the cut surface by adopting the thermoformed faces (yet to be cut) for the side faces of the ink absorbent under both ends of the ink supply port formation surface.

With the cutting thus made, it becomes possible to process the cut faces in the same condition as at the time of being installed along the inner faces of an ink tank, and to suppress the irregular surface condition which may locally present the uneven compression to be created when compressed after cut without compression. In this manner, the cut faces can be formed to be flat in a state of being compressed, hence securing the close contactness between each of the ink adsorbents and the inner faces of each ink tank when installed in it. As a result, the ink tank 30 can supply ink smoothly, because there are no local wrinkle or any unwanted gaps formed for any one of the ink adsorbents 34, 35, and 36 in each of the installation chambers. In this manner, it is possible to attain printing in good condition.

In accordance with the present invention described above, a part or the entire surface of the ink absorbent having the thermoformed surface, which abuts against the inner wall faces of an ink tank is cut to enhance the deformability and resiliency thereof for the provision of higher close contactness with the inner wall face of the ink tank. As a result, the short supply of ink due to the creation of bubbles, as well as the ink leakage can be prevented, thus providing a highly reliable ink tank having a higher performance of ink supply. Also, it becomes possible for the ink absorbent to maintain the abutting condition better against an ink jet recording head. No excessive load is needed when an ink tank is installed on a head. Thus, there is no fear that the structural members themselves are damaged.

Further, with the cutting under compression, it becomes possible to arrange the structure so that an ink absorbent may present the most stabilized condition in a state of being installed in an ink tank. Therefore, from the viewpoint of ink supply, the ink absorbent is formed to provide the most preferable condition of installation in the ink tank.

What is claimed is:

1. An ink absorbent formed by fiber material having face structured by a cut face.

2. An ink absorbent contained in the housing of an ink tank for storing ink in the interior thereof provided with a supply port for leading out ink to the outside, and an atmospheric communication port to be communicated with the air outside, being formed by fiber material having the surface formed at least by thermoforming, wherein
the face of said ink absorbent facing said supply port on the inner face of said ink tank is a cut face.

3. An ink absorbent according to claim 2, wherein the face of said ink absorbent abutting upon a rib on the inner face of said ink tank is the non-cut thermoformed face thereof.

4. An ink absorbent according to claim 2 or claim 3, wherein the face of said ink absorbent facing the atmospheric communication port of said ink tank is the non-cut thermoformed face thereof.

5. An ink absorbent contained in the housing of an ink tank for storing ink in the interior thereof provided with a supply port for leading out ink to the outside, and an atmospheric communication port to be communicated with the air outside, being formed by fiber material having the surface formed at least by thermoforming, wherein
the face of said ink absorbent facing the plane having the largest area on the inner face of said ink tank is the cut face thereof.

6. An ink absorbent according to claim 5, wherein said ink tank comprises a negative pressure generating member installation chamber; a liquid storage chamber communicated with said negative pressure generating member installation chamber through communication passage to store ink to be supplied to said negative pressure generating member installation chamber substantially closed with the exception of said communication portion; and a partition wall member having said communication passage, partitioning said negative pressure generating member installation chamber and said liquid storage chamber.

7. An ink absorbent according to claim 6, wherein the face of said ink absorbent facing said partition wall member is the cut face thereof.

8. An ink absorbent contained in the housing of an ink tank for storing ink in the interior thereof provided with a supply port for leading out ink to the outside, and an atmospheric communication port to be communicated with the air outside, being formed by fiber material having the surface formed at least by thermoforming, wherein
two faces of said ink absorbent opposite to each other are the cut faces.

9. An ink absorbent according to claim 8, wherein said cut faces are parallel in the fiber direction.

10. An ink tank containing an ink absorbent according to either one of claim 2 to claim 9 in the interior thereof.

11. An ink absorbent compressed and inserted into the interior of an ink tank housing for installation to retain ink, wherein
said ink absorbent is cut into the inner shape of the ink tank housing under the same condition of compression as at the time of insertion thereof into the ink tank.

12. An ink absorbent according to claim 11, wherein the degree of compression at the time of cutting is lower than that of the compressed state after the insertion into the ink tank.

13. An ink absorbent according to claim 12, wherein said ink absorbent is formed by foaming material or fiber material.

14. An ink absorbent according to claim 11 or claim 12, wherein said ink absorbent is formed by laminating two or more fiber blocks.

15. An ink tank provided with an ink absorbent capable of retaining ink, and a housing having said ink absorbent installed therein and an atmospheric communication port, wherein
said ink absorbent is cut into the inner shape of the ink tank housing under the same compressed state as at the time of insertion into the ink tank.

16. An ink jet cartridge comprising:
an ink tank provided with an ink absorbent capable of retaining ink, and a housing having said ink absorbent installed therein, said ink absorbent being cut into the inner shape of the ink tank housing under the same compressed state as at the time of insertion into the ink tank; and
a printing head for discharging ink supplied from said ink tank.

17. A method for manufacturing an ink absorbent compressed and inserted into an ink tank housing to be able to retain ink, comprising the following steps of:
making said ink absorbent to be in the same compressed state as at the time of insertion into the ink tank; and
cutting said ink absorbent into the inner shape of said ink tank housing.

18. An ink tank provided with an ink absorbent cape of retaining ink, and a housing having said ink absorbent installed therein and an atmospheric communication port, comprising the following steps of:
making said ink absorbent to be in the same compressed state as at the time of insertion into the ink tank;
cutting said ink absorbent into the inner shape of said ink tank housing; and
inserting said ink absorbent into the ink tank housing under compression.
